(19) United States
(12) Patent Application Publication
(10) Pub. No.: US 2006/0216126 A1
(43) Pub. Date: Sep. 28, 2006

(54) Magnetic wheelchair seating belt storage system

(76) Inventor: Richard Mechling, Wilmington, NC (US)

Correspondence Address: RICHARD MECHLING, 214 North 6th Street, Wilmington, NC, 28401, US

(21) Appl. No.: 11/377,015

(22) Filed: Mar. 15, 2006

Related U.S. Application Data
(60) Provisional application No. 60/663,674, filed on Mar. 22, 2005.

(51) Int. Cl. B60P 3/06

(52) U.S. Cl. 410/7

(57) ABSTRACT

A method and a system for retaining wheelchair seating belts when the user is out of the wheelchair. A magnetized body is secured to an area of the wheelchair in a placement which allows the user to easily reach the seating belt storage location. A second ferrous based element is connected to the seating belts to allow the belts to be held by the magnet.

### FIELD OF THE INVENTION

The present invention relates to the retaining of wheelchair seating and positioning belts when the wheelchair user is not sitting in the wheelchair. The invention relates more specifically to using magnetic force to hold seating belts in a convenient location so that the wheelchair user may easily gain access to the seat belts and trunk support belts upon again assuming the seated position.

It has long been a problem for some wheelchair users to regain grasp of their wheelchair seat belts, chest-support belts, or other individualized supports upon moving back to the seated position. Such belts often fall between the wheels and the wheelchair frame, or otherwise fall out of reach after the buckles are unfastened. This is a particular problem for some wheelchair users, as the type of paralysis which causes them to use a wheelchair also may extend to the trunk, shoulder, and arm musculature used reaching for their belts. Seat belt retractors have long been used to pull belts back to one set location after a user has left the seat of vehicles, as in the seat belt retractor described by Martin in U.S. Pat. No. 6,439,494. However, the retractable seatbelt systems do not provide resistance-free belt movement and do not provide variable location needed to allow ease of access for the wheelchair user with significant upper extremity motor deficit.

### SUMMARY OF THE INVENTION

The present invention provides a method and an apparatus which satisfies the aforementioned needs. To provide the wheelchair user with seatbelt storage placement that is individualized in location, that provided minimal resistance against detachment, and that requires minimal dexterity for use, the described invention includes a magnet and a means of attachment for that magnet to various wheelchair locations which accommodate the user's movement abilities.

A preferred embodiment of this apparatus includes a magnet connected to a fastening strip with an array of hooks on one side typical of the fastening strips routinely sold and registered under the trademark “VELCRORTM”. The magnet is chosen to be of sufficient strength to hold the weight of wheelchair seating belts which either include ferrous based material or have iron based seat belt buckles. Using the hook sided fastening strip, the magnet is connected to a wheelchair in one a wide variety of locations. Two magnets with hook fastening strips can be used to allow a magnet to be connected to both left and right wheelchair sides for the retaining of both left and right seat belt sides. The secure and reliable location of the magnets can be assured by first affixing the back of a piece of adhesive-backed loop fastening strip to the desired location of the wheelchair seat or frame. Then the hook fastening strip connected to the magnet can be connected to the loop fastening strip. The wheelchair user's own unique movement abilities secondary to their paralysis and musculoskeletal abnormalities are to be considered, and the magnet location that allows for the simplest belt access is chosen.

This preferred embodiment overcomes many of the difficulties faced by many disabled individuals attempting to independently use their positioning belts. Using this magnetic belt holding system, the wheelchair user can attach their belts to an accessible wheelchair placement after they unbuckle their straps. The magnetic attraction to ferrous elements in an iron seat belt buckle allows the subjects with reduced coordination or vision to merely make contact between buckle and magnet with no manipulation of clasps or snaps. The nature of magnets is that the provide near no holding force once the buckle is removed from direct contact, so that the user with reduced strength is not trying to rebuckle their straps while fighting the resistance of a retractable spring-based system. As the magnet location is variable, belt storage location can be adjusted should there be change in the status of the user's motor skill or rehabilitation. Note that choosing a site for application of a magnetic element can be done without the use of hook and loop fastening strips as means of attachment. Many such options of using this system exist such as placement of a cylindrical magnet within the frame or by even replacing part of the frame with other magnetic materials.

Various ancillary attachments and adjustments can be made to this apparatus to allow it to be used most effectively with people of differing degrees of disability. For the more paralyzed user who is dependent on trunk support to maintain sitting, a ferrous based ring or clamp can be added to the trunk support straps so that they too can be stored against the magnets. Ferrous based attachments can likewise be made to any seating belts which have plastic seating belt buckles. In this case, the wheelchair user may be dependent on an attendant for transfers to and from the wheelchair, and the retaining magnets may be preferably located at the back of the wheelchair near the push handles for the attendant's use.

Accordingly, it is the object of the present invention to provide improved storage of wheelchair seating belts in convenient locations when the belts are not in use.

It is another object of the present invention to provide a magnetic seatbelt holder for\ the securing and storage of wheelchair seating and positioning belts.

It is another object of the present invention to provide increased independence in managing wheelchair positioning belts to the subject with visual or motor control deficits.

It is another object of the present invention to provide a magnetic holder for wheelchair seatbelts and positioning belts whose location can be adjusted to accommodate the individualized motor skills of the wheelchair user.

### BRIEF DESCRIPTION F THE DRAWINGS

FIG. 1 is a perspective view of the preferred embodiment.

FIG. 2 is a perspective view of the preferred embodiment.

### DESCRIPTION OF THE PREFERRED EMBODIMENT

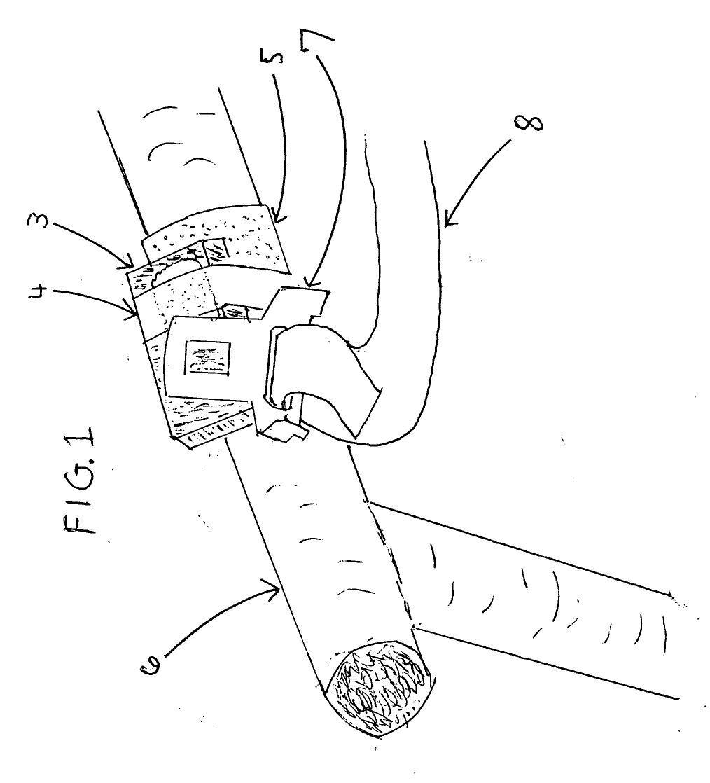

Referring now to the drawing in which like numbers indicate elements throughout, FIG. 1 shows a preferred embodiment of a magnetic wheelchair seating belt storage system in accordance with the present invention.

A ceramic magnet 3 is attached with adhesive to a hook loop fastening strip 4. A loop fastening strip 5 is attached with adhesive to wheelchair armrest 6 in a location chosen to accommodate the wheelchair user's motor skills. Hook fastening strip 4 is attached to the loop fastening strip 5 to hold ceramic magnet 3 adjacent to the chosen site of magnet attachment. Ferrous based wheelchair positioning buckle 7 is in contact with ceramic magnet 3. Wheelchair seating belt 8 is wound through wheelchair positioning belt buckle 7, and thus wheelchair positioning belt 8 is held in secure and convenient storage.

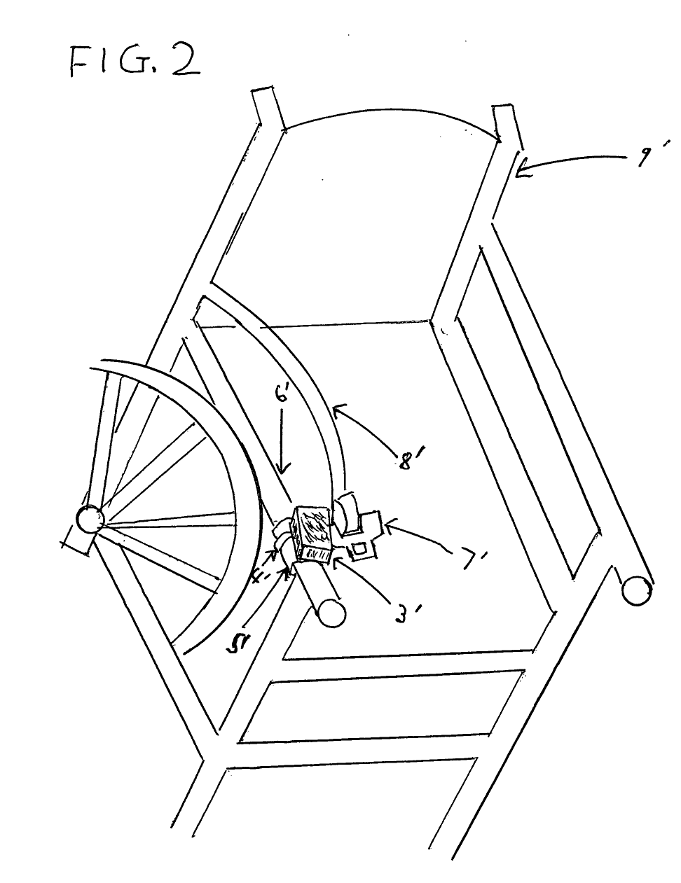

FIG. 2 is a broader perspective view of a preferred embodiment to illustrate the present invention in context with the full wheelchair seat. In this case hook fastener strip 4′ is adhesively attached to ceramic magnet 3′. Loop fastener strip 5′ has its back attached with adhesive to wheelchair armrest 6′. Hook fastener strip 4′ is wrapped around loop fastener strip 5′ to hold the ceramic magnet 3′ adjacent to wheelchair armrest 6′. Ferrous based seat buckle 7′ is in direct contact with ceramic magnet 3′. Wheelchair seating belt 8′ is wound through a slot in wheelchair seat buckle 7′ to effectively maintain secure and convenient storage of wheelchair positioning belt 8′.

The preferred embodiment of the present invention has been described by way of example, and it will be understood that other modifications may occur by those skilled in the art without departing from the scope of the appended claims.

I claim:

1. A magnetic wheelchair seating belt storage system comprising:
a magnetic body;
attachment means for said magnetic body to a wheelchair;
a ferrous based body in contact with said magnetic body, and;
a wheelchair positioning belt connected to said ferrous body.

2. A method of providing storage for wheelchair positioning belts comprising the steps of:
providing a magnetic body;
providing attachment means of said magnetic body to a wheelchair;
choosing a wheelchair placement for said magnetic body on said wheelchair, and;
attaching said magnetic body to said wheelchair placement using said magnetic body attachment means.
